(19) United States
(12) Patent Application Publication
(10) Pub. No.: US 2007/0130782 A1
(43) Pub. Date: Jun. 14, 2007

(54) Saw alignment device, blade assembly, and method for cutting a workpiece

(76) Inventor: Lewis Barton, Mooresville, NC (US)

Correspondence Address: Schwartz Law Firm, P.C.;SouthPark Towers, Suite 530, 6100 Fairview Road, Charlotte, NC, 28210, US

(21) Appl. No.: 11/299,838

(22) Filed: Dec. 12, 2005

(51) Int. Cl. B23D 45/16

(52) U.S. Cl. 30/371; 30/388

(57) ABSTRACT

A blade aligning device is adapted for use with a hand-held saw. The saw includes a cutting blade. The aligning device includes a forked alignment member having an elongated body, first and second diverging legs, and a crotch region formed by a junction of the first and second legs. The first and second legs engage a workpiece located at the crotch region, and cooperate to stabilize the saw and align the cutting blade relative to the workpiece during cutting. A pivot pin attaches the alignment member to the hand-held saw.

### TECHNICAL FIELD AND BACKGROUND OF THE INVENTION

This invention relates to an alignment device and blade assembly adapted for incorporation in hand-held saws; particularly circular power saws for cutting PVC and PE pipe used in pipe construction. The invention further relates to a method for cutting a workpiece. In one application, the invention mechanically aligns the blade, and cuts and bevels the pipe in a single cutting operation, thereby facilitating field cuts, reducing labor costs, creating a precisely beveled end, and promoting efficient pipe assembly and construction.

### SUMMARY OF INVENTION

Therefore, it is an object of the invention to provide a blade aligning device especially adapted for incorporation in hand-held saws.

It is another object of the invention to provide a blade assembly especially adapted for incorporation in hand-held saws.

It is another object of the invention to provide a hand-held saw which is mechanically stabilized during cutting.

It is another object of the invention to provide a hand-held saw comprising a blade which is mechanically aligned relative to the workpiece during cutting.

It is another object of the invention to provide a hand-held saw which facilitates field-cutting PVC and PE pipe in pipe construction projects.

It is another object of the invention to provide a hand-held saw including a blade assembly which safely cuts and bevels a workpiece, such as pipe and angle iron, in a single cutting operation.

It is another object of the invention to provide a hand-held saw which reduces the labor cost and improves safety of pipe construction.

It is another object of the invention to provide a hand-held saw including a blade assembly which first squares and then bevels the pipe end in a single cutting operation.

It is another object of the invention to provide a hand-held saw which promotes efficient pipe assembly and construction.

It is another object of the invention to provide a blade aligning device and blade assembly which can be easily retrofit on existing commercial power saws.

It is another object of the invention to provide a method for aligning a saw blade relative to a workpiece during cutting.

It is another object of the invention to provide a method for cutting and beveling a workpiece in a single cutting operation.

These and other objects of the present invention are achieved in the preferred embodiments disclosed below by providing a blade aligning device adapted for use with a hand-held saw. The saw includes a cutting blade. The aligning device comprises a forked alignment member having an elongated body, first and second diverging legs, and a crotch region formed by a junction of the first and second legs. The first and second legs engage a workpiece located at the crotch region, and cooperate to stabilize the saw and align the cutting blade relative to the workpiece during cutting. Means are provided for attaching the alignment member to the hand-held saw.

The term “blade” includes any device with a cutting edge or surface, such as an abrasive disk, circular blade, hack saw blade, handsaw blade, band saw blade, and the like.

Preferably, the aligning device includes first and second forked alignment members. Each member has an elongated body, first and second diverging legs, and a crotch region formed by a junction of the first and second legs.

According to another preferred embodiment of the invention, the first and second alignment members are spaced-apart and adapted for being located along a length of the workpiece.

According to another preferred embodiment of the invention, the alignment member may include a plurality of workpiece-engaging teeth formed with at least one of the first and second legs.

Preferably, the alignment member has a plurality of workpiece-engaging teeth formed with both of the first and second legs.

According to another preferred embodiment of the invention, the first and second legs of the alignment member form an angle therebetween of at least 90 degrees.

According to another preferred embodiment of the invention, the first and second legs of the alignment member are of approximately equal length.

According to another preferred embodiment of the invention, a single leg of the alignment member has a length less than 50% of a length of the body of the alignment member.

According to another preferred embodiment of the invention, the means for attaching includes a pivot pin adapted for enabling pivoting movement of the alignment member relative to the saw and workpiece during cutting.

In another embodiment, the invention is a hand-held saw including a cutting blade adapted for cutting a workpiece, and a blade aligning device. The aligning device is adapted for engaging the workpiece to stabilize the saw and align the cutting blade relative to the workpiece during cutting. The aligning device includes a forked alignment member having an elongated body, first and second diverging legs, and a crotch region formed by a junction of the first and second legs. The first and second legs engage the workpiece located at the crotch region of the alignment member. Means, such as a pivot pin, attaches the alignment member to the hand-held saw.

In yet another embodiment, the invention is a hand-held saw incorporating a blade assembly and blade aligning device. The blade assembly includes a saw blade adapted for creating a first cut in a workpiece. The first cut defines a substantially square, sheered edge of the workpiece. A rotary bevel cutter is located adjacent the saw blade, and is adapted for creating a second cut in the workpiece. The second cut is made at an angle to the first cut, thereby beveling the sheered edge of the workpiece. The blade aligning device is adapted for engaging the workpiece to stabilize the saw and align the blade assembly relative to the workpiece during cutting. The aligning device comprising a forked alignment member having an elongated body, first and second diverging legs, and a crotch region formed by a junction of the first and second legs. The first and second legs engage the workpiece located at the crotch region of the alignment member. Means, such as a pivot pin, attaches the alignment member to the hand-held saw.

The term “beveling” is used broadly herein to mean any curve, angle, or slant on a surface. For example, two adjoining surfaces, if not at right angles are “beveled”.

According to another preferred embodiment of the invention, the saw blade is circular and operatively mounted for rotation relative to the workpiece.

According to another preferred embodiment of the invention, the saw blade and bevel cutter are located side by side, and operatively mounted for rotation about a common axis.

According to another preferred embodiment of the invention, the saw blade and bevel cutter are fixedly secured together for rotating in unison relative to the workpiece (i.e., such that one of the blade and cutter does not slip relative to the other during cutting).

According to another preferred embodiment of the invention, the bevel cutter has a circular base and plurality of outwardly projecting teeth.

According to another preferred embodiment of the invention, the teeth of the bevel cutter are spaced apart along an outer circumference of the base.

According to another preferred embodiment of the invention, adjacent teeth of the bevel cutter are circumferentially-spaced about 90 degrees apart.

According to another preferred embodiment of the invention, the saw blade has an outer diameter greater than two times an outer diameter of the base of the bevel cutter.

In yet another embodiment, the invention is a method for cutting a workpiece. The method includes the step of creating a first cut through a surface of a workpiece using a blade assembly. The first cut defines a substantially square, sheered edge of the workpiece. While creating the first cut, a second cut is simultaneously formed in the surface of the workpiece. The second cut is made at an angle to the first cut thereby beveling the sheered edge of the workpiece. During the first and second cuts, the blade assembly is mechanically aligned relative to the workpiece. The term “mechanical” refers to automatically aligning utilizing the tool or aligning device of the present invention.

The term “simultaneously” is used broadly herein to mean creating first and second cuts in the workpiece in a single cutting operation (i.e., without removing the saw from the workpiece after the first cut in order to create the second cut).

According to another preferred embodiment of the invention, the method includes rotating the workpiece while simultaneously creating the first and second cuts.

According to another preferred embodiment of the invention, the step of creating the first and second cuts comprises utilizing a hand-held saw having a saw blade and a bevel cutter.

According to another preferred embodiment of the invention, the step of aligning the blade assembly comprises locating the saw blade substantially perpendicular to a longitudinal axis of the workpiece, thereby squaring the blade relative to the workpiece.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a side view of a hand-held saw incorporating a blade aligning device according to one preferred embodiment of the present invention;

FIG. 2 is a side view of a single alignment member of the blade aligning device;

FIG. 3 is an exploded view of the blade aligning device;

FIG. 4 is a side view of the hand-held saw with the blade aligning device in a releasably stowed position;

FIG. 5 is a side view of a hand-held saw according to a second preferred embodiment of the present invention, and showing a portion of the guard broken away to better illustrate the novel blade assembly;

FIG. 6 is an enlarged view of the blade assembly with the larger-diameter circular blade shown in cross-section, and the smaller-diameter bevel cutter engaging and beveling a sheered edge of the pipe in a single cutting operation;

FIG. 7 is an exploded perspective view of the blade assembly;

FIG. 8 is a fragmentary cross-sectional view of the blade assembly; and

FIG. 9 is an enlarged, fragmentary, perspective view of the blade assembly.

### DESCRIPTION OF THE PREFERRED EMBODIMENT AND BEST MODE

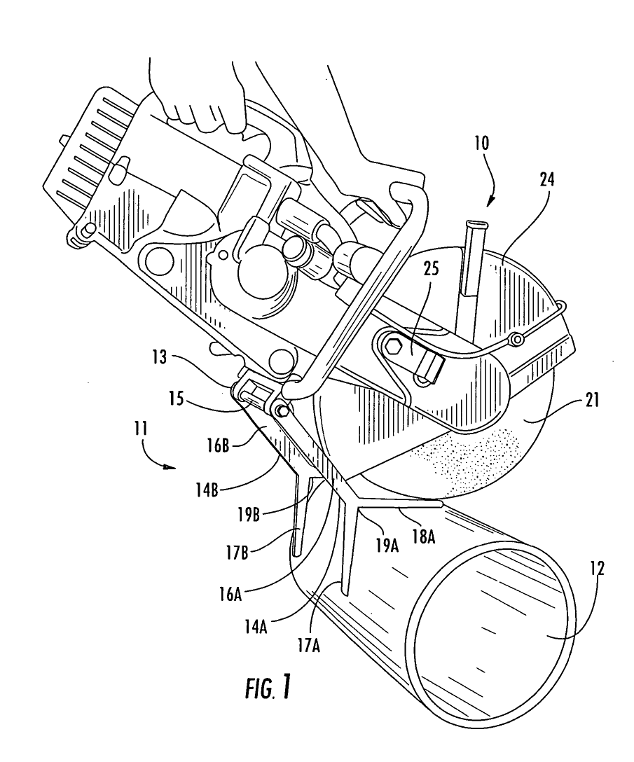

Referring now specifically to the drawings, a hand-held saw according to the present invention is illustrated in FIG. 1, and shown generally at reference numeral 10. The hand-held saw 10 incorporates an adjustable blade aligning device 11, described further below. In one application, the invention comprises a circular power saw especially applicable for cutting PVC and PE pipe 12 used in the pipe construction industry. Alternatively, the present aligning device 11 may be incorporated in other hand-held manual or power saws including hacksaws, band saws, handsaws, chain saws, and the like. Preferably, the aligning device 11 depends from mounting structure 13 fixed to the power saw 10.

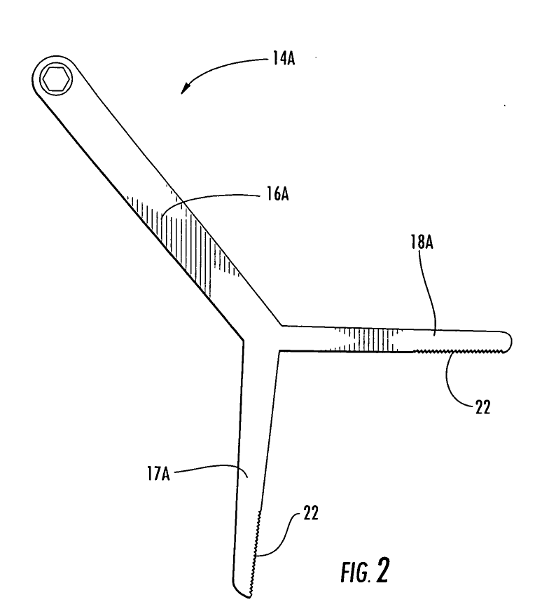

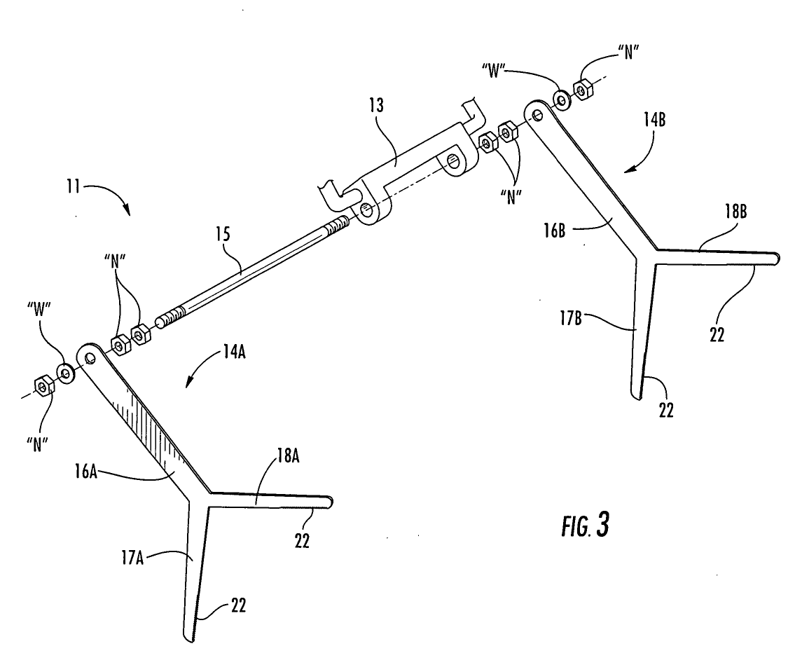

As best shown in FIGS. 1 and 3, the blade aligning device 11 comprises first and second spaced-apart, identical, forked alignment members 14A and 14B adjustably attached to the power saw 10 using an end-threaded pivot pin 15 and suitable hardware, such as nuts “N” and washers “W”. Each alignment member 14A, 14B has an elongated body 16A, 16B, first and second diverging legs 17A, 18A and 17B, 18B, and a crotch region 19A, 19B formed by a junction of the first and second legs 17A, 18A and 17B, 18B. The first and second legs 17A, 18A and 17B, 18B engage the pipe 12 located at the crotch region 19A, 19B of the alignment member 14A, 14B, and cooperate to stabilize the saw 10 and align the cutting blade 21 relative to the pipe 12 during cutting. As shown in FIG. 2, the first and second legs 17A, 18A of alignment member 14A preferably form a substantially 90 degree angle “α” at the crotch region 19A, and are of substantially equal length. Alignment member 14B (not shown in FIG. 2) is preferably identical to alignment member 14A. The length of each leg 17A, 18A and 17B, 18B is less than 50% of the length of the elongated body 16A, 16B.

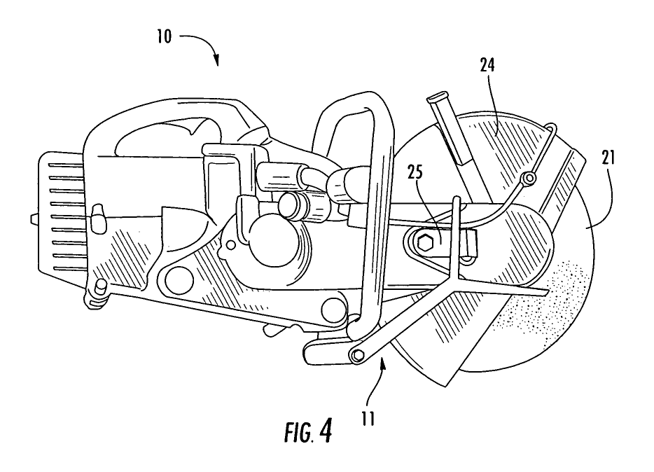

During operation of the power saw 10, the blade aligning device 11 engages the pipe 12, as shown in FIG. 1, and mechanically squares the blade 21 for fast and precise cutting. While cutting, the user places his foot on the pipe 12 and uses the foot to slowly rotate the pipe 12 in a counterclockwise direction (towards himself). Preferably, the legs 17A, 18A and 17B, 18B of each alignment member 14A, 14B have teeth 22 designed to facilitate gripping and rotation of the pipe 12. After cutting, the blade aligning device 11 is conveniently pivoted to a stowed position, shown in FIG. 4, adjacent a blade guard 24 of the power saw 10. A spring clip 25 or other retaining means releasably holds the device 11 in this position until further use.

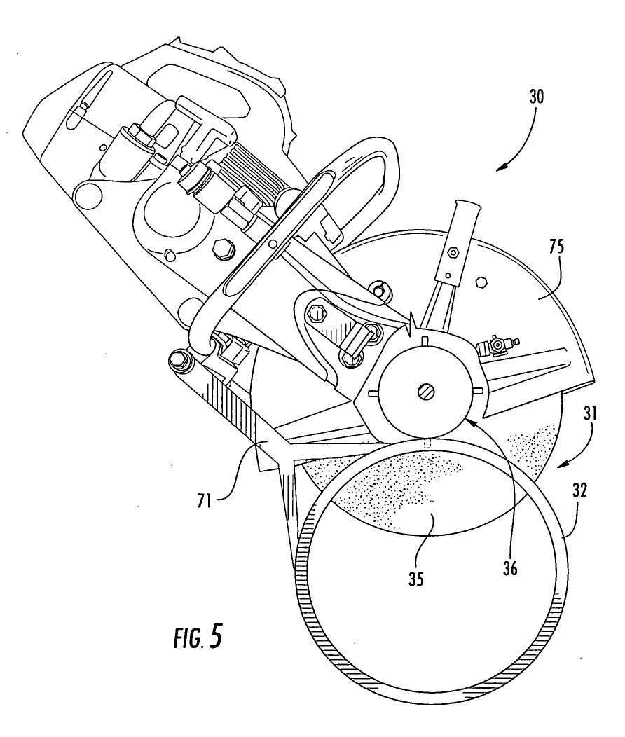

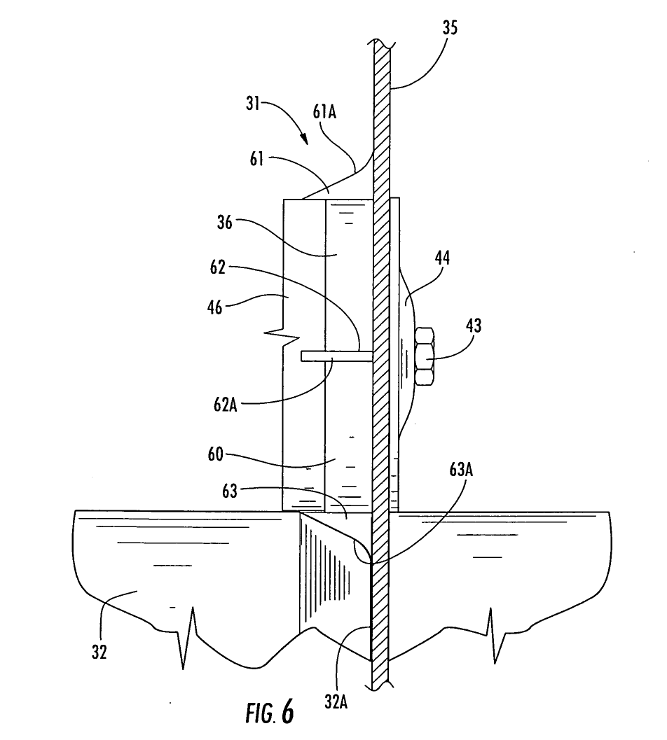

A further embodiment of a hand-held saw 30 according to the present invention is illustrated in FIGS. 5-9. The saw incorporates a novel blade assembly indicated generally at reference numeral 31 in FIGS. 5 and 6.

In one application, such as that described above, the hand-held saw 30 comprises a circular power saw especially applicable for field-cutting PVC and PE pipe 32 used in the pipe construction industry. Alternatively, the present blade assembly 31 may be incorporated in other hand-held saws including hacksaws, band saws, handsaws, chain saws, and the like. Utilizing the present blade assembly 31, the hand-held saw 30 first squares and then immediately bevels a sheered edge 32A of the pipe 32 in a single cutting operation, as described further below.

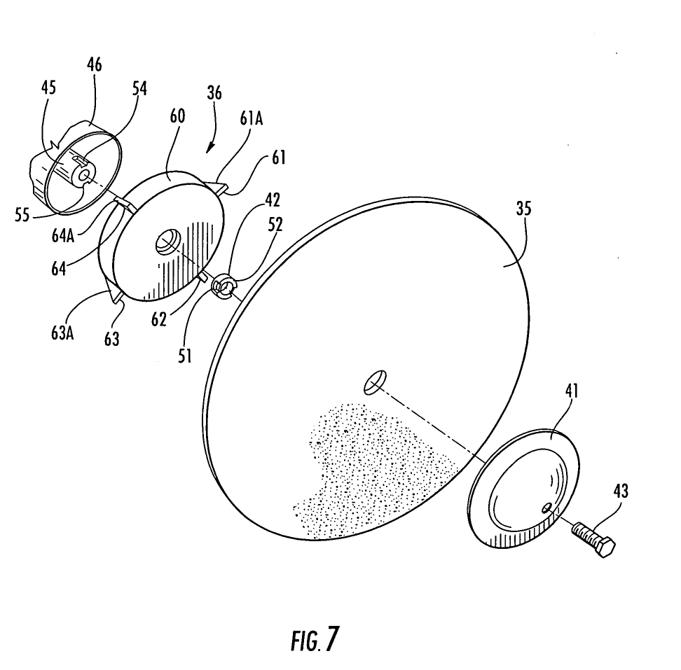

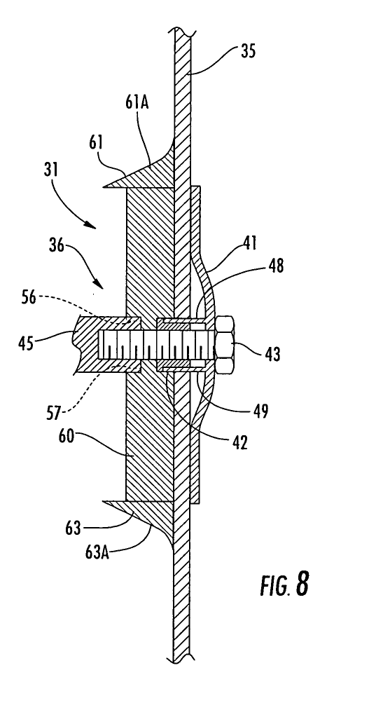

Referring to FIGS. 7, 8, and 9, the blade assembly 31 comprises a relatively large-diameter circular blade 35, a smaller diameter bevel cutter 36, and mounting hardware designed to fixedly secure the circular blade 35 and bevel cutter 36 to the power saw 30. The mounting hardware includes a mounting plate 41, locking nut 42, and threaded bolt 43. As best shown in FIG. 8, the threaded bolt 43 extends through aligned openings formed with the mounting plate 41, locking nut 42, circular blade 35, and bevel cutter 36, and into a complementary internally-threaded cylinder 45 formed with the rotary base 46 of the power saw 30. The threaded bolt 43 defines a notional axis about which the circular blade 35 and bevel cutter 36 rotate in unison relative to the pipe 32 during operation of the power saw 10. Preferably, the mounting plate 41 has projecting inside fingers 48, 49 which insert into respective notches 51, 52 formed with the locking nut 42 to help prevent slippage of the circular blade 35 when creating the first cut in the pipe 32. Similarly, the rotary base cylinder 45 of the power saw 30 has opposing notches 54, 55 which receive complementary extensions 56, 57 integrally-formed with the bevel cutter 36 adjacent its center hole to help prevent slippage of the bevel cutter 36 when creating the second cut in the pipe 32.

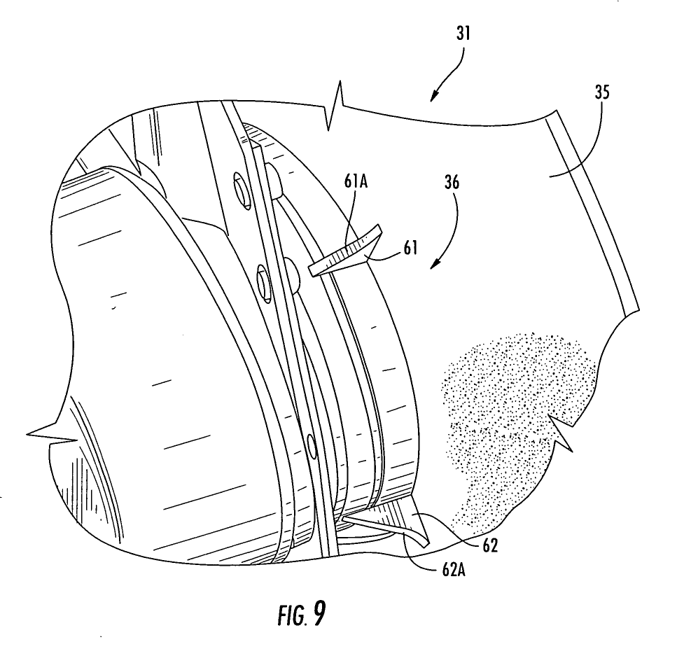

The bevel cutter 36 has a circular base 60 and a number of equally spaced teeth 61, 62, 63, and 64 with respective sharpened cutting edges 61A, 62A, 63A, and 64A, best shown in FIGS. 7 and 9. In the embodiment shown, the bevel cutter 36 comprises four teeth 61-64 which are spaced approximately 90 degrees apart. The teeth 61-64 are angled relative to the axis of rotation such that upon engaging the sheered pipe edge 32A, the cutting edges 61A-64A cooperate to transform the initial square cut made by the circular blade 35 to a finished bevel cut. Preferably, the finished cut forms about a 15 degree bevel. Depending on wall thickness, the bevel can be up to 1½″ for either PVC or PE pipe.

Operation of the power saw 30 is best illustrated with reference again to FIGS. 5 and 6. To facilitate alignment of the blade assembly 31, the power saw 30 preferably includes an aligning device 71 comprising a pair of forked alignment members (only one shown) designed to engage the pipe 32, stabilize the power saw 30, and keep the circular blade 35 square during cutting. The aligning device 71 is preferably identical to the aligning device 11 described above. Based on the diameter of the pipe 32, the orientation of the blade guard 75 can be rotated forward or rearwardly to one of several releasably set positions in order to properly located the bevel cutter 36 relative to the sheered pipe edge 32A when forming the second cut in the pipe 32. During cutting, the user places his foot on the pipe 32 and uses the foot to slowly rotate the pipe 32 in a counterclockwise direction, as previously described. The circular blade 35 first engages and cuts through an outer surface of the pipe 32 creating a square, sheered annular edge 32A. As the circular blade 35 is moved through the pipe 32 towards the blade's axis of rotation, the angled cutting teeth 61-64 of the bevel cutter 36 then engage the squared pipe edge 32A and create a second cut forming the bevel 80.

A blade assembly for a hand-held saw is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A blade aligning device adapted for use with a hand-held saw including a cutting blade, said aligning device comprising:
a forked alignment member comprising an elongated body, first and second diverging legs, and a crotch region formed by a junction of said first and second legs, whereby said first and second legs engage a workpiece located at said crotch region, and cooperate to stabilize the saw and align the cutting blade relative to the workpiece during cutting; and
means for attaching said alignment member to the hand-held saw.

2. A blade aligning device according to claim 1, and comprising first and second forked alignment members each comprising an elongated body, first and second diverging legs, and a crotch region formed by a junction of said first and second legs.

3. A blade aligning device according to claim 1, wherein said alignment member comprises a plurality of workpiece-engaging teeth formed with at least one of said first and second legs.

4. A blade aligning device according to claim 1, wherein the first and second legs of said alignment member form an angle therebetween of at least 90 degrees.

5. A blade aligning device according to claim 1, wherein said means for attaching comprises a pivot pin adapted for enabling pivoting movement of said alignment member relative to the saw and workpiece during cutting.

6. A hand-held saw, comprising:
a cutting blade adapted for cutting a workpiece; and
a blade aligning device adapted for engaging the workpiece to stabilize the saw and align said cutting blade relative to the workpiece during cutting, said aligning device comprising:
(i) a forked alignment member having an elongated body, first and second diverging legs, and a crotch region formed by a junction of said first and second legs, whereby said first and second legs engage the workpiece located at said crotch region; and
(ii) means for attaching said alignment member to the hand-held saw.

7. A hand-held saw, comprising:
a blade assembly including a saw blade adapted for creating a first cut in a workpiece, the first cut defining a substantially square, sheered edge of the workpiece, and a rotary bevel cutter located adjacent said saw blade, and adapted for creating a second cut in the workpiece, the second cut being made at an angle to the first cut thereby beveling the sheered edge of the workpiece; and
a blade aligning device adapted for engaging the workpiece to stabilize the saw and align said blade assembly relative to the workpiece during cutting, said aligning device comprising:
(i) a forked alignment member having an elongated body, first and second diverging legs, and a crotch region formed by a junction of said first and second legs, whereby said first and second legs engage the workpiece located at said crotch region; and
(ii) means for attaching said alignment member to the hand-held saw.

8. A hand-held saw according to claim 7, wherein said saw blade of said blade assembly is circular and operatively mounted for rotation relative to the workpiece.

9. A hand-held saw according to claim 8, wherein said saw blade and bevel cutter of said blade assembly are located side by side, and operatively mounted for rotation about a common axis.

10. A hand-held saw according to claim 9, wherein said saw blade and bevel cutter of said blade assembly are fixedly secured together for rotating in unison relative to the workpiece.

11. A hand-held saw according to claim 10, wherein said bevel cutter of said blade assembly comprises a circular base and plurality of outwardly projecting teeth.

12. A hand-held saw according to claim 11, wherein the teeth of said bevel cutter are spaced apart along an outer circumference of the base.

13. A hand-held saw according to claim 12, wherein adjacent teeth of said bevel cutter are circumferentially-spaced about 90 degrees apart.

14. A hand-held saw according to claim 13, wherein said saw blade has an outer diameter greater than two times an outer diameter of the base of said bevel cutter.

15. A hand-held saw according to claim 7, wherein said alignment member of said blade aligning device comprises a plurality of workpiece-engaging teeth formed with at least one of said first and second legs.

16. A hand-held saw according to claim 7, wherein said means for attaching said alignment member comprises a pivot pin adapted for enabling pivoting movement of said blade aligning device relative to the saw and workpiece during cutting.

17. A method for cutting a workpiece comprising the steps of:
creating a first cut in a workpiece using a blade assembly, the first cut defining a substantially square, sheered edge of the workpiece;
while creating the first cut, simultaneously creating a second cut in the workpiece, the second cut being made at an angle to the first cut thereby beveling the sheered edge of the workpiece; and
mechanically aligning the blade assembly relative to the workpiece during cutting.

18. A method for cutting a workpiece according to claim 17, and comprising rotating the workpiece while simultaneously creating the first and second cuts.

19. A method for cutting a workpiece according to claim 17, wherein the step of creating the first and second cuts comprises utilizing a hand-held saw having a saw blade and a bevel cutter.

20. A method for cutting a workpiece according to claim 19, wherein the step of aligning the blade assembly comprises locating the saw blade substantially perpendicular to a longitudinal axis of the workpiece.
